(19) United States
(12) Patent Application Publication
(10) Pub. No.: US 2021/0246706 A1
(43) Pub. Date: Aug. 12, 2021

(54) EMERGENCY DOOR ACTUATION

(71) Applicant: Ratier-Figeac SAS, Figeac Cedex (FR)

(72) Inventors: Emmanuel HOURADOU, Cardaillac (FR); Raphael PLATA, Cuzac (FR)

(21) Appl. No.: 17/166,136

(22) Filed: Feb. 3, 2021

(30) Foreign Application Priority Data
Feb. 10, 2020 (EP) 20305126.3

(51) Int. Cl. E05F 15/50; B64C 1/14; B64D 25/08

(52) U.S. Cl. CPC E05F 15/50; B64C 1/1423; B64D 25/08; E05Y 2900/502; E05Y 2201/456; E05Y 2201/474; E05Y 2201/426

(57) ABSTRACT

An emergency actuation device for opening a door, the emergency actuation device includes: at least one pressurised gas supply; an actuator including: an actuator chamber, an actuator piston moveable between a retracted position and a fully extended position to open the door, a vent for venting the actuator chamber when the actuator piston is in its extended position. The emergency actuation device further includes a percussion device including a percussion piston moveable on activation of the percussion device between: a storage position in which the pressurised gas supply is isolated from the actuator and an activated position in which the pressurised gas supply is coupled to the actuator. The actuator is coupled to the percussion device; and the actuator is configured such that movement of the actuator piston towards its activated position resets the percussion piston.

### FOREIGN PRIORITY

This application claims priority to European Patent Application No. 20305126.3 filed Feb. 10, 2020, the entire contents of which is incorporated herein by reference.

### TECHNICAL FIELD

This disclosure relates to devices for emergency door actuation, in particular for aircraft doors.

### BACKGROUND

Doors, such are those which are commonly found in aircraft, are provided with actuation devices which are intended for use in emergency situations. These emergency actuation devices operate to force the door open rapidly in an emergency. For example, in aircraft for both civil and military applications, such devices are fitted to aircraft evacuation doors, which are intended to be used to evacuate people quickly from the aircraft in an emergency. Emergency actuation devices are provided on aircraft doors which normally function as embarkation/disembarkation doors for passengers, crew and/or support staff also function as emergency doors. In this application the emergency actuation devices must operate to force the door open in an emergency situation, but they should not interfere with the normal operation of the door (i.e. opening and closing in non-emergency situations).

Known emergency actuation devices for doors generally comprises a pneumatic cylinder with a piston and a chamber. The pneumatic cylinder is connected to the opening mechanism of the door. In the case of an emergency, the chamber is provided with a supply of pressurised gas which acts upon the piston, urging it to an extended position thereby opening the door. Generally, during normal operation the chamber is vented to the atmosphere to allow the normal operation of the door.

Known emergency door actuation devices commonly include a percussion device having a membrane which inhibits the flow of the pressurised gas from a gas supply, such as a tank or a pyrotechnic gas generator, to the pneumatic cylinder. Following a manual activation, for example with an emergency lever or button, the membrane is pierced which allows pressurised gas to flow from a gas supply into the chamber.

After operation of the emergency door actuation device, the supplied gas must be allowed to vent from the system or be forced from the system in order for the door to be closed again. In known systems, it is necessary to wait until all pressurised gas released into the various components of the device and the gas from the pressurised gas supply itself is vented. In some situations, it can often be important to close the door quickly. Waiting for the gas to exhaust complete from the actuation system can cause unacceptable delays in reclosing the door.

Therefore, there is a need to improve existing emergency actuation arrangements for doors.

### SUMMARY

According to a first aspect of this disclosure, there is provided an emergency actuation device for opening a door, the emergency actuation device comprising: at least one pressurised gas supply; an actuator including: an actuator chamber, an actuator piston moveable between a retracted position and a fully extended position to open the door, a vent for venting the actuator chamber when the actuator piston is in its extended position. The emergency actuation device further comprising a percussion device including a percussion piston moveable on activation of the percussion device between: a storage position in which the pressurised gas supply is isolated from the actuator and an activated position in which the pressurised gas supply is coupled to the actuator. Wherein the actuator is coupled to the percussion device; and wherein the actuator is configured such that movement of the actuator piston towards its activated position resets the percussion piston.

The emergency actuation device utilises only the pressurised gas required to operate the actuator. Excess gas is not wasted because the flow of pressurised gas supply into the system is stopped (cut off) following operation of the actuator. Furthermore, since there is a limited amount of pressurised gas to be evacuated from the device, the time taken to vent the device is less than with conventional devices. This means that the actuator returns to atmospheric pressure more quickly and consequently the door can be reclosed in a much shorter time following activation.

Before activation of the emergency actuation device energy is stored in the form of the pressurised gas. Following activation, the energy is released and transferred to the actuator and used to open the door. The emergency actuation device consumes only the energy required.

The actuator may be configured such that movement of the actuator piston past an intermediate position causes the percussion piston to return to its storage position.

The emergency actuation device may comprise a pressure quick release valve provided between the percussion device and the actuator. The pressure quick release valve may be operable to move the percussion piston to its rest position;

The actuator may be configured to operate the pressure quick release valve. The actuator may be configured to move the piston of the pressure quick release valve from its non-operational position.

The actuation chamber may include an outlet in fluid communication with the pressure quick release valve. The outlet may be is located such that when the actuator piston has passed its intermediate position pressurised gas flows to the pressure quick release valve.

The actuator chamber may be coupled to the pressure quick release valve such that when the actuator piston passes the intermediate position, the actuator chamber is fluid communication with the pressure quick release valve to operate the pressure quick release valve.

The percussion device may include an inlet in fluid communication with the pressurised gas supply. The percussion device may include an outlet in fluid communication with the actuator. The percussion device may be configured such that when the percussion piston is in its storage position, a seal is located between the inlet and the outlet. The percussion device may be configured such that when the percussion piston is in its activated position, the inlet is in fluid communication with the outlet.

The pressurised gas supply may be at least one gas storage tank. The pressurised gas supply may be at least one pyrotechnic gas generator. The pressurised gas may be nitrogen.

The percussion device may be integrally formed with the pressure quick release valve. The percussion device may be coupled to the pressure quick release valve. The percussion device may be coupled to the pressure quick release valve such that movement of the pqry piston causes a reset of the percussion device. In other words, the movement of the pqry causes the percussion piston to return to its storage position.

The emergency actuation device may comprise a resilient means. The resilient means may bias the percussion piston to its storage position. The resilient means may bias the pressure quick release valve piston to a non-activated position. The resilient means may be a spring. The resilient means may be a coil spring.

The pressure quick release valve piston may be configured to return to its non-activated position after the percussion device is reset.

The emergency actuation device may further comprise a trigger. The trigger may be operably coupled to the percussion device for activating the percussion device.

The actuator vent may be configured for atmospheric venting. The actuator may comprise two or more vents each vent being configured for venting the actuator chamber when the actuator piston is in its extended position.

According to a further aspect of this disclosure, there is provided a door comprising an emergency actuation device according to any preceding claim, wherein the actuator includes an actuator body, and wherein one of the actuator body and the piston is coupled to the door, and the other of the actuator body and the piston is coupled to a door frame.

The door may be an aircraft door. The door may be an aircraft evacuation door. The door may be provided in a building.

Features described in relation to the first aspect of the present disclosure may of course also be applied to the further aspects, and vice versa. In general, features of any example described herein may be applied wherever appropriate to any other example described herein. Where reference is made to different examples or sets of examples, it should be understood that these are not necessarily distinct but may overlap.

### BRIEF DISCRIPTION OF THE DRAWINGS

Certain examples of this disclosure will now be described, by way of example only, and with reference to the accompanying drawings, in which:

FIG. 1 shows a schematic view of an emergency actuation device according to an example of the present disclosure in a non-operational position;

FIG. 2 shows a schematic view of the emergency actuation device of FIG. 1 in a first operational position;

FIG. 3 shows a schematic view of the emergency actuation device of FIG. 1 in a second operational position;

FIG. 4 shows a schematic view of the emergency actuation device of FIG. 1 in a third operational position;

FIG. 5 shows a schematic view of the emergency actuation device of FIG. 1 in a fourth operational position; and

FIG. 6 shows a schematic view of the emergency actuation device of FIG. 1 after operation.

### DETAILED DESCRIPTION

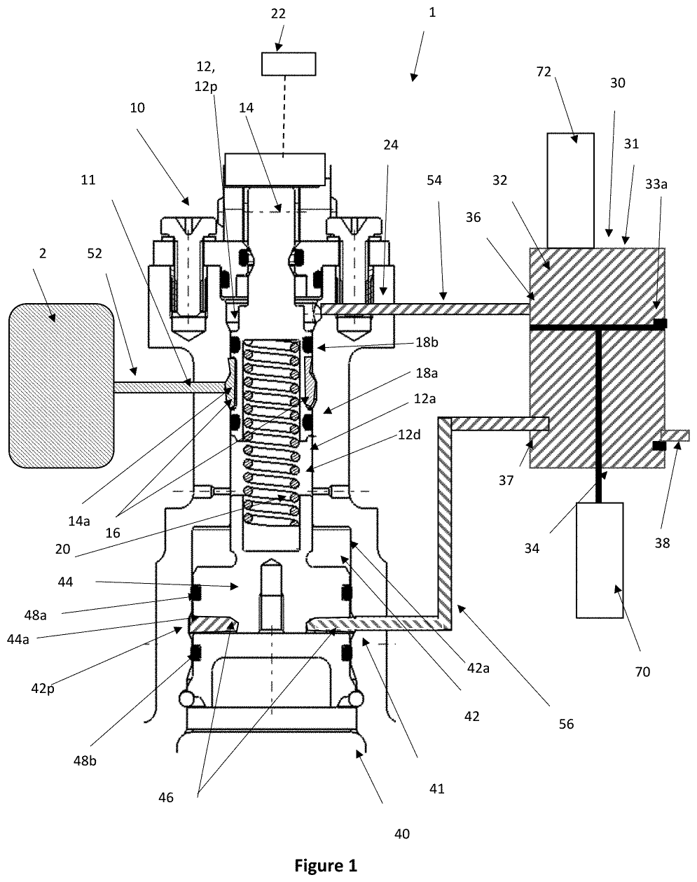

FIG. 1 shows an emergency actuation device 1, comprising a pressurised gas supply 2; a percussion device 10, a user interface 22, an actuator 30, and a pressure quick release valve (PQRV) 40.

In the example shown in FIG. 1 the percussion device 10 is formed integrally with the pressure quick release valve (PQRV) 40. In other examples, these components can be formed separately and coupled together.

The pressurised gas supply 2 is any suitable device or arrangement for providing a supply of pressurised gas, such as a gas tank or a pyrotechnic gas generator. It will be appreciated that the pressurised gas supply 2 may comprise two or more gas tanks, two or more pyrotechnic gas generators.

The pressurised gas supply 2 is fluidly coupled to an inlet 11 of the percussion device 10 via a first duct 52. The percussion device 10 includes a chamber 12 having a chamber wall 12a, and a percussion piston 14 moveable within the chamber 12. A spring 20 biases the percussion piston 14 so that it is urged into in a first position in a proximal portion 12p of the chamber 12. The inlet 11 leads to a ring shaped chamber 16, which is formed between a circumferential recess 14a in the percussion piston 14 and the chamber wall 12a. Two seals 18a, 18b, for example as O-rings, are provided on the percussion piston 14, providing a seal with the chamber wall 12a, such that in the position shown in FIG. 1, the ring shaped chamber 16 is not in fluid communication with the proximal portion 12p and a distal portion 12d of the chamber 12. A trigger (or user interface) 22 is coupled to the percussion device 10 in such a way that on activation of the trigger 22 a downwards force on the percussion piston 14. The trigger 22 could be mechanically coupled to the percussion piston 14, for example the trigger 22 could be a lever or button with a mechanical linkage to the percussion piston 14. Alternatively, the trigger 22 could be electronically or wirelessly coupled to the percussion piston 14, for example trigger 22 could be an electrical switch powering a small electrical actuator that pushes on the percussion piston 14.

An outlet 24 of the percussion device 10 is fluidly coupled to an inlet 36 of the actuator 30 via a second duct 54. The actuator 30 is a pneumatic cylinder having a body 31, a variable volume chamber 32 and an actuator piston 34. The actuator piston 34 is moveable from a retracted position to an extended position. The actuator 30 includes a vent 38 for atmospheric venting, and an outlet 37. The exhaust vent 38 is further along the piston stroke than the outlet 37.

As schematically shown in this example, the actuator piston 34 is coupled to a door 70 and the cylinder body 31 is coupled to a door frame 72 of the door 70. However, it will be appreciated that the actuator piston 34 could be coupled to the door frame 72 and the cylinder body 31 could be coupled to the door 70.

The outlet 37 of the actuator 30 is fluidly coupled to an inlet 41 of the pressure quick release valve (PQRV) 40 via a third duct 56. The PQRV 40 includes a chamber 42 and a PQRV piston 44 which is movable within the chamber 42, and a seal 48a provided on the PQRV piston 44. The inlet 41 leads to a ring shaped chamber 46, which is formed between a shoulder 44a on the PQRV piston 44 and a chamber wall 42a. The seal 48a prevents gas escaping from the ring shaped chamber 46. The PQRV 40 includes a second seal 48b. The spring 20 biases the PQRV piston 44 in its non-operational position at a proximal portion 42p of the chamber 42.

FIG. 1 represents the emergency actuation device in a non-operational or stored configuration. A spring 20 is provided which acts upon both the percussion piston 14 and the PQRV piston 44. The biasing force of the spring 20 urges the percussion piston 14 upwards in its storage (non-operational) position. Due to the seals 18a 18b, pressurised gas from the pressurised gas supply 2 is retained in the ring shaped chamber 16 within the percussion device 10. The actuator piston 34 is in its retracted position, and an abutment 33a prevents the actuator piston 34 from moving past the inlet 36. Atmospheric gas fills the actuator chamber 32, the second and third ducts 54, 56 and the PQRV ring-shaped chamber 46. In the PQRV 40, the seals 48a and 48b retain the atmospheric gas in the ring shaped chamber 46, and the spring 20 urges the PQRV piston 44 into its non-operational position.

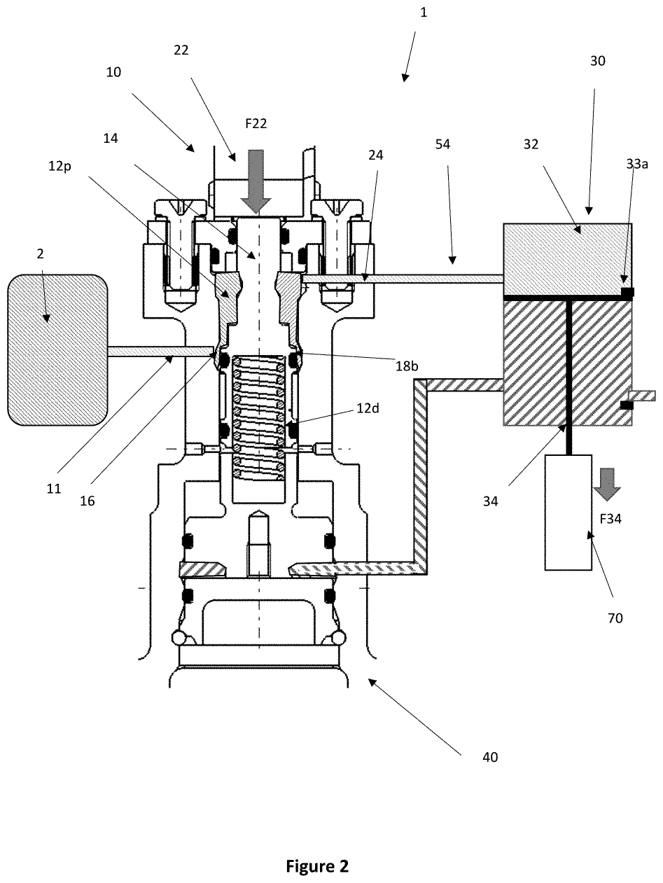

FIGS. 2 to 6 schematically show the operational stages of the emergency actuation device 1 of FIG. 1. For ease of understanding, the door and door frame are not represented in all Figures, and not all reference signs are depicted.

FIG. 2 shows the emergency actuation device 1 of FIG. 1 in a first operational position, immediately following activation of the trigger 22. Activation of the trigger 22 results in a force F22 being applied to the percussion piston 14. The percussion piston 14 moves away from its storage position and the first seal 18b is no longer in contact with the chamber wall 12a, which means that the ring shaped chamber 16 is in fluid communication with the proximal portion 12p of the chamber 12. The pressurised gas from the pressurised gas supply 2 flows into the proximal portion 12p of the chamber 12, through the outlet 24, into the first duct 52 and then into the actuator chamber 32. Pressurised gas in the actuator chamber 32 exerts a force F34 on the actuator piston 34, and the actuator piston starts to move away from its retracted position.

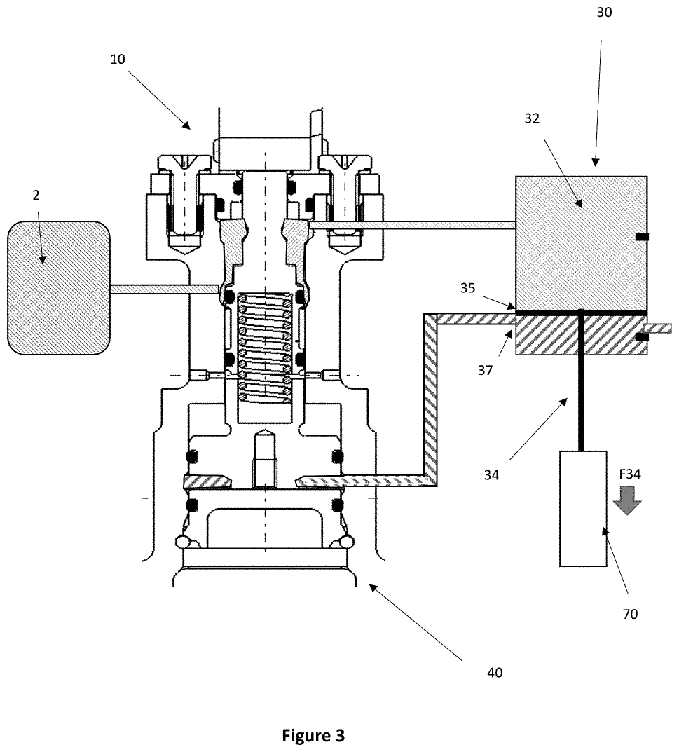

FIG. 3 shows the emergency actuation device 1 of FIG. 1 in a second operational position. Pressurised gas continues to flow from the pressurised gas supply 2, through the percussion device 10 and into the actuator chamber 32. As the volume of pressurised gas in the actuator chamber 32 increases, the force F34 urges the actuator piston 34 further away from its retracted position, to an intermediate position. In this intermediate position, as the actuator piston 34 has not moved past the actuator outlet 37, so the pressurised gas continues to build up in the actuator chamber 32. The movement of the actuator piston 34 forces open the door 70.

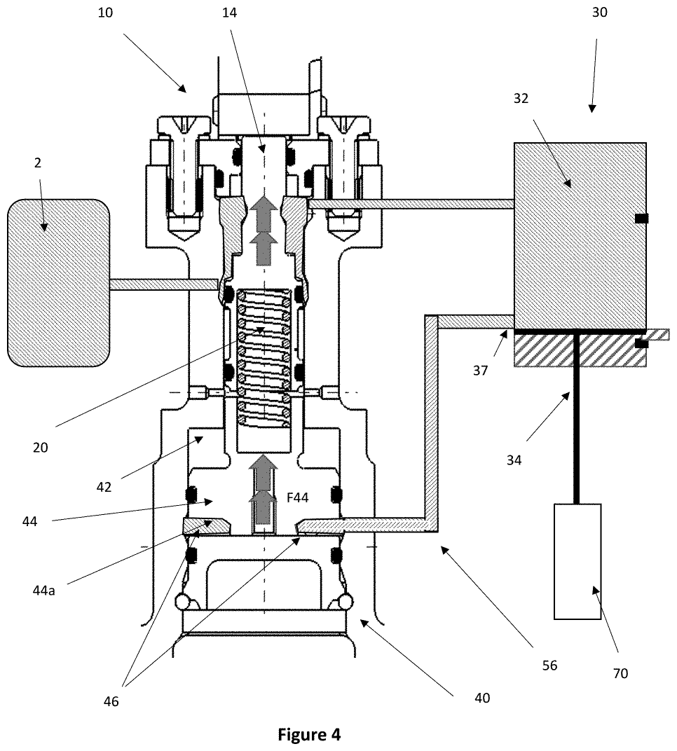

FIG. 4 shows the emergency actuation device 1 of FIG. 1 in a third operational position in which the actuator piston 34 has travelled beyond the intermediate position, i.e. beyond the actuator outlet 37, to its fully extended position. A second abutment 33b limits the travel of the actuator piston 44. This means that the actuator chamber 32 is in fluid communication with the third duct 56, so that the pressurised gas passes through the third duct 56 to the ring shaped chamber 46 of the PQRV 40. As the pressurised gas enters the chamber 46 it urges the PQRV piston 44 away from its non-operational position, with a force F44. As the PQRV piston 44 moves upwards, it pushes against the spring 20 which in turn imparts a force on the percussion piston 14.

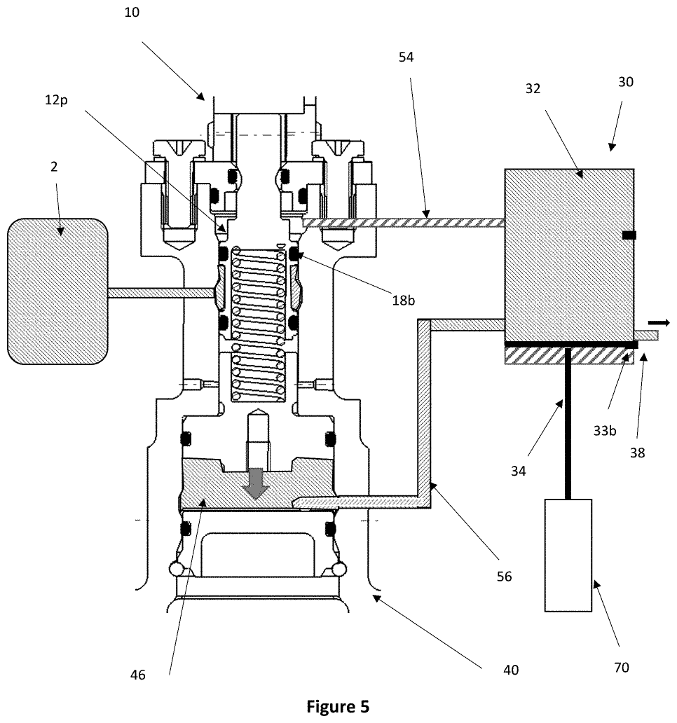

FIG. 5 shows the emergency actuation device 1 of FIG. 1 in a fourth operational position in which the PQRV piston 44 and spring 20 have pushed the percussion piston 14 back into its non-operational position. The first seal 18b now prevents further pressurised gas from passing into the proximal portion 12p of the chamber 12. This means that any pressurised gas which was not used during the operation of the emergency actuation device 10 remains in the pressurised gas supply 2, first duct 52 and ring shaped chamber 16. In other words, the unused pressurised gas need not be vented from the device 1.

In the actuator 30, the actuator piston 34 has travelled to its fully extended position, beyond the actuator exhaust 38. This results in pressurised gas venting out through the exhaust 38 from the remainder of the device 1, i.e. from the second and third ducts 54, 56, the PQRV 40 and the actuator 30. As the pressurised gas vents from the PQRV 10, the spring 20 urges the PQRV piston 44 back into its non-operational position.

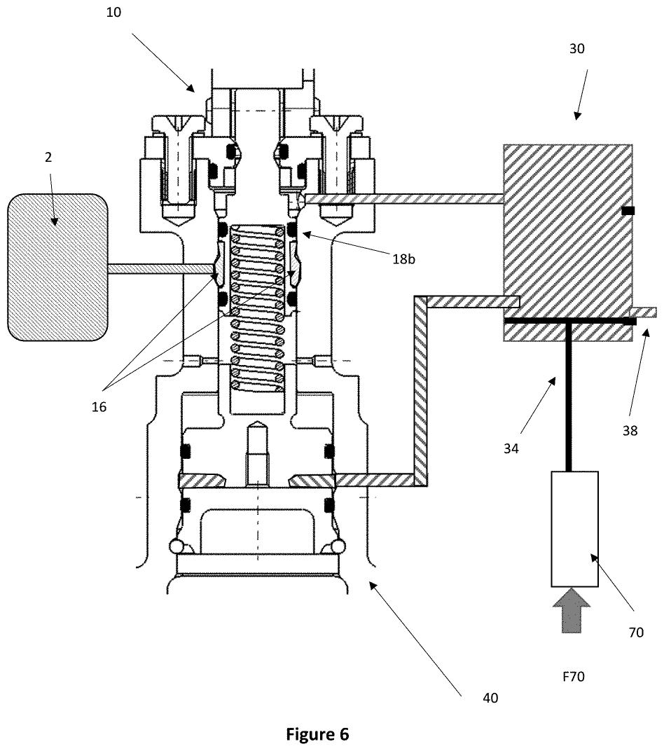

FIG. 6 shows the emergency actuation device 1 of FIG. 1 in a fifth operational position in which substantially all the pressurised gas from the second and third ducts 54, 56, the PQRV 40 and the actuator 30 has been vented from the system. Therefore, the actuator chamber 32 is essentially at atmospheric pressure, and the actuator piston 34 is at its fully extended position. With the device in this state, an operator can apply a force F70 to the door 70 to close it, and the emergency actuation device 1 is reset to its non-operational or stored configuration.

It will be appreciated that this type of emergency activation device can be used for doors in a wide range of vehicular applications, for example in aircraft and other vehicles. They can also be used in other industries such construction, for example, as emergency actuation devices for doors in buildings or rooms. Further, it is noted that in all these applications, the term door can also refer to doors for chambers or compartments which are not intended for people to pass through.

In certain situations two or more emergency activation devices can be provided on a single door. In this case, a single trigger can be coupled to the percussion device of each emergency activation devices in such a way that on activation of the trigger a downwards force on each percussion piston 14.

The pressurised gas may be nitrogen, compressed air or any other suitable compressed gas.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of the disclosure. Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

1. An emergency actuation device for opening a door, comprising:
at least one gas supply; and
an actuator including:
an actuator chamber;
an actuator piston moveable between a retracted position and a fully extended position to open the door,
a vent for venting the actuator chamber when the actuator piston is in its extended position; and
a percussion device including a percussion piston moveable on activation of the percussion device between: a storage position in which the pressurised gas supply is isolated from the actuator and an activated position in which the pressurised gas supply is coupled to the actuator;
wherein the actuator is coupled to the percussion device; and wherein the actuator is configured such that movement of the actuator piston towards its activated position resets the percussion piston.

2. The emergency actuation device according to claim 1, wherein the actuator is configured such that movement of the actuator piston past an intermediate position causes the percussion piston to return to its storage position.

3. The emergency actuation device according to claim 1, further comprising a pressure quick release valve provided between the percussion device and the actuator, wherein the pressure quick release valve is operable to move the percussion piston to its rest position.

4. The emergency actuation device according to claim 3, wherein the actuator is configured to operate the pressure quick release valve.

5. The emergency actuation device according to claim 3, wherein the actuator chamber includes an outlet in fluid communication with the pressure quick release valve, and wherein the outlet is located such that when the actuator piston has passed its intermediate position.

6. The emergency actuation device according to claim 1, wherein the percussion device includes an inlet in fluid communication with the pressurised gas supply and an outlet in fluid communication with the actuator, wherein when the percussion piston is in its storage position, a seal is located between the inlet and the outlet; and
when the percussion piston is in its activated position, the inlet is in fluid communication with the outlet.

7. The emergency actuation device according to claim 1, wherein the pressurised gas supply is at least one gas storage tank.

8. The emergency actuation device according to claim 1, wherein the pressurised gas is nitrogen.

9. The emergency actuation device according to claim 1, wherein the percussion device is integrally formed with the pressure quick release valve.

10. The emergency actuation device according to claim 9, further comprising a resilient means biasing the percussion piston in its storage position.

11. The emergency actuation device according to claim 10, wherein the resilient means biases the pressure quick release valve piston to a non-activated position.

12. The emergency actuation device according to claim 11, wherein the pressure quick release valve piston is configured to return to its non-activated position after the percussion device is reset.

13. The emergency actuation device according to claim 1, further comprising a trigger operably coupled to the percussion device for activating the percussion device.

14. The emergency actuation device according to claim 1, wherein the vent is configured for atmospheric venting.

15. A door comprising:
an emergency actuation device according to claim 1,
wherein the actuator includes an actuator body; and
wherein one of the actuator body and the actuator piston is coupled to the door, and the other of the actuator body and the actuator piston is coupled to a door frame.
